(19) United States
(12) Patent Application Publication
(10) Pub. No.: US 2011/0316249 A1
(43) Pub. Date: Dec. 29, 2011

(54) BICYCLE FORK

(75) Inventor: Vincenz Thoma, Koblenz (DE)

(73) Assignee: Canyon Bicycles GmbH

(21) Appl. No.: 12/832,372

(22) Filed: Jul. 8, 2010

(30) Foreign Application Priority Data
Jun. 24, 2010 (DE) 20 2010 009 492.5

(51) Int. Cl. B62K 21/02

(52) U.S. Cl. 280/279

(57) ABSTRACT

A bicycle fork, particularly a bicycle fork for a racing bicycle, comprises two fork legs connected to each other by a fork bridge. On the respective dropout ends of the fork legs, recesses are provided for receiving a front-wheel axis. For allowing the front-wheel axis to be arranged in different positions in the longitudinal direction of the frame and, thereby, to be able to change the trail, a positioning element is arranged within the recesses. The positioning element can be turned by 180° and thus be inserted into the recess or be exchanged in different positions. Effected thereby is a change the position of an opening which serves for receiving a front-wheel axis.

### BACKGROUND

1. Field of the Disclosure

The present disclosure relates to a bicycle fork, particularly a bicycle fork for a racing bicycle.

2. Discussion of the Background Art

Bicycle forks, which in modern racing bicycles, particularly those in the high-quality segment, are made from carbon or other fiber-reinforced plastics, are of considerable relevance for the running behavior of a bicycle. Apart from the flexibility of the bicycle fork, the forward reach of the fork is of decisive importance for the running behavior of a bicycle. By the forward reach of the fork, the trail of the running wheel at the front, i.e. the front wheel, can be adjusted. The trail is defined as the distance between the actual contact point of the front wheel with the road while the bicycle is running straight ahead, and the theoretical contact point which is defined by the extension of the fork shaft axis. Since bicycle forks are normally curved in a forward direction, a corresponding trail is generated, with the axis of the front wheel being displaced forwardly, i.e. in the running direction, relative to the longitudinal axis of the fork shaft. A corresponding displacement of the bicycle axis in the forward direction will of course also result from a forward inclination of the fork tubes relative to the fork shaft axis.

If the axis of the front wheel is located farther to the front when seen in the running direction, i.e. if the fork has a larger forward reach, this will result in a smaller trail. Thereby, the bicycle will have an enhanced maneuverability. If, on the other hand, said axis is located farther to the rear, i.e. closer to the longitudinal axis of the fork shaft, the bicycle fork has a smaller forward reach. Such an arrangement would result in a larger trail, allowing the bicycle to run more smoothly. Especially during fast rides downhill, this is of advantage.

It is an object of the disclosure to provide a bicycle fork by which the running behavior of the bicycle can be improved.

### SUMMARY

By the bicycle fork of the disclosure, it is rendered possible to change the forward reach and, respectively, to change the trail. Thus, the bicycle fork of the disclosure offers the possibility to set the running behavior of the bicycle as desired.

The bicycle fork of the disclosure comprises two fork legs connected to each other by a bicycle bridge. Said bicycle bridge is preferably connected to a fork shaft. With preference, said fork shaft is a one-pieced fork shaft made of fiber-reinforced plastic such as carbon. On the respective dropout ends, the two fork legs are formed with a recess for receiving a front-wheel axis. Said recesses are shaped as slots which are open in a downward direction, i.e. towards the road surface, so that the front axis can be inserted from below and can be fixed in the dropout ends of the bicycle fork, preferably with the aid of a quick-release fastener. According to the disclosure, the recesses are formed in a manner allowing for fixing front-wheel axis in at least two different positions, preferably in the longitudinal direction of the frame, i.e. in the running direction. Thereby, for instance, the front-wheel axis can be fixed in the recesses in a first or front position and a second or rear position. By fixing the axis in said front position, one will realize a bicycle fork with larger forward reach and thus smaller trail. Obtained thereby is an increased maneuverability of the bicycle. By fixing the front-wheel axis in a rearward position, the forward reach will be reduced while the trail will be increased. Thereby, the running smoothness of the bicycle is improved.

According to a first embodiment, it is provided that, at least in the region where the front-wheel axis will be fixed, said recesses have a width, i.e. a dimension in the longitudinal direction of the frame, which is larger than the diameter of the front-wheel axis. This makes it possible to shift the front-wheel axis within the recess in the longitudinal direction of the frame. Depending on the respective positioning of the front-wheel axis, the remaining portion of the recess can be closed by a securing element or the like. For instance, a suitably shaped member made of plastic or a metal alloy can be inserted into the remaining recess so as to avoid an unintended movement of the front-wheel axis into the respective other position. In this embodiment, the recesses can be configured as downwardly open, slotted recesses which along their entire width have a width dimension larger than the diameter of the front-wheel axis. Particularly, it is also possible that the recesses on their openings have the usual width which is only slightly larger than the diameter of the front-wheel axis, the recesses then becoming wider in the upward direction or at least having a cutout region extending in the longitudinal direction of the frame. When viewed from the side, the recess can be P- or T-shaped, for instance. In case of a P-shaped recess, the front-wheel axis can be shifted into the cutout region which is oriented e.g. in or against the longitudinal direction of the frame, or it can be inserted linearly from below without lateral displacement. A corresponding displacement of the front-wheel axis to the front or the rear will be possible in case of a T-shaped recess. Also in this case, it is preferred that the remaining opening of the recess is closed by a securing element to avoid unintended displacement of the front-wheel axis.

According to a particularly preferred embodiment, each of said recesses is provided with a positioning element arranged therein. In this embodiment, the recesses have at least partially a width which is larger than the diameter of the front-wheel axis. Said positioning element is configured to guarantee a defined position of the front-wheel axis. The positioning elements are removable from the recesses and, for instance, can be replaced by other positioning elements. The different positioning elements herein are formed to the effect that they will realize different positions of the front-wheel axis. For this purpose, the positioning elements preferably comprise openings, more preferably slotted openings. The front-wheel axis can be fitted through these two openings, or the axis can be inserted into the openings from below. Said openings of the positioning elements thus form the conventional recesses of dropout ends of bicycle forks. The positioning elements are preferably shaped to the effect that they can fill out, preferably fully, the recesses—which are enlarged as provided by the disclosure—on the dropout ends. Thus, by simple exchange of the positioning elements, different positions of the front-wheel axis and thus different trails of the front-wheel axis can be realized in a simple manner. This way, it is made possible to adapt the running behavior to the preferences of the bicycle rider and/or to the currently intended use of the bicycle.

According to a particularly preferred embodiment, the positioning elements are configured in such a manner that one and the selfsame positioning element can be inserted in different orientations into the recess of the dropout ends. Particularly, in this embodiment, it is possible to rotate the positioning element by 180° so that, in one orientation of the positioning element, an opening for receiving the front-wheel axis is arranged at a farther forward position and, in another orientation, said opening is arranged in a farther rearward position. A corresponding arrangement of the positioning elements in different positions rotated by 180° to each other can also be achieved, particularly, by exchanging the—in the running direction—left and right positioning elements while simultaneously rotating them by 180° about a substantially vertical axis.

Preferably, the positioning elements are fastened in the respective dropout end of the fork legs respectively via a fastening element such as, e.g., by a screw. However, fastening the positioning elements can also be performed by use of fastening elements in the form of locking elements and the like. Particularly for stiffening the dropout ends of the fork legs, the dropout ends are preferably provided with respective inserts or holding elements, preferably made of metal, which simultaneously form said recesses. Especially within such an insert or holding element, the respective positioning element can be attached in a reliable manner. Preferably, the insert or holding element can comprise a threaded bore adapted for insertion of a screw for attachment of the positioning element. Further, said holding element, made e.g. of aluminum, can comprise a threaded insert such as e.g. a Heli-Coil so as to allow for frequent mounting processes. In this case, the positioning element, e.g. the above-mentioned screw, is preferably arranged to be screwed into, or fixed in, the holding element from below. In such an arrangement, the screwhead holds the positioning element, with the screwhead preferably being arranged in a counterbore, thus avoiding abutment of the front-wheel axis on the screwhead.

According to a particularly preferred embodiment, the positioning element, when seen in lateral view, is substantially L-shaped or hook-shaped. Upon insertion of the positioning element into said recess, one leg is oriented substantially vertically, and the other, upper leg is oriented substantially horizontally. Consequently, it is only when the positioning element has been inserted into the preferably slotted recess that the slot for receiving the front-wheel axis will be generated. Therefore, the slot is, on the one hand, laterally limited by a lateral wall of the vertical leg of the positioning element, and, on the other hand, it is limited by a lateral wall of the recess. According to the preferred embodiment, the upper abutment face for the front-wheel axis forms the vertical leg of the positioning element.

This has the advantage that, in this region, i.e. in the region of the horizontal leg, the fastening element for the screws can be provided. Thus, the substantially L-shaped cross-sectional configuration of the positioning elements offers the advantage that the positioning element has a smaller width because the lateral walls of the slotted recess do not need to be formed by the positioning element. A further advantage of the L-shaped configuration of the positioning elements resides in the convenient attachment which is made possible via the substantially horizontal leg at the metallic holding elements, preferably in the dropout ends.

Preferably, the positioning elements, particularly the horizontal leg in case of a substantially L-shaped configuration, comprise a curved, preferably circular axis-abutment face. This axis-abutment face, which in lateral view is preferably shaped as a circular arc, serves for surface-to-surface abutment of the front-wheel axis. Herein, the arc of said axis-abutment face is preferably in the range of 90°-180°, more preferably 120°-140°. According to a particularly preferred embodiment, the positioning element comprises, in the region of the abutment face, a throughgoing bore for fitting therethrough said fastening element together with the screw. Accordingly, said thoroughgoing bore is preferably oriented vertically and is preferably formed with a recess for accommodating the screwhead. In this arrangement, preferred use is made of socket head screws. Such an enclosure of the axis will guarantee a safe positioning of the front-wheel axis. Particularly, there is also guaranteed a horizontal orientation of the front-wheel axis.

To ensure a safe fixation of the positioning elements, it is particularly preferred that the positioning elements comprise two clamping faces which are oriented to face toward the fork bridge, i.e. toward each other in upward directions. The width of the positioning elements thus becomes narrower in the upward direction. The recesses provided in the dropout ends or in the holding elements preferably comprise corresponding clamping faces.

When a positioning element is inserted from below into the recess, the clamping faces will thus be brought into mutual abutment. By fixing the positioning element with the aid of the fastening element, e.g. a screw, a form-locked clamping attachment is effected. This is the case particularly if the fastening element is an element by which the positioning element will be pulled further upward in the direction of the fork bridge. This is achieved preferably with the aid of a screw which will be screwed into a vertical bore formed in the dropout end and respectively in the holding element. In order to compensate for manufacturing tolerances and to guarantee a reliable clamping effect, a gap is provided between an upper side of the positioning element and an inner side of the recess. Thus, the positioning element abuts, by its upper side, not on the inner side of the recess but exclusively on the clamping faces.

By the provision of the inventive positioning element and, respectively, of the corresponding configuration of the recesses, it is made possible to change the trail by more than 3 mm, preferably more than 4 mm and more preferably more than 5 mm. According to a preferred embodiment, this is carried out by simply rotating the positioning element by 180° about a vertical axis while, preferably, an exchange between the left positioning element and the right positioning element is performed at the same time.

By the inventive possibility of changing the trail, the ride characteristics of the bicycle can be changed in a simple manner because already a slight change of the trail will result in a considerable change of the trail of the bicycle. Particularly, by suitably changing the trail, one can thus perform an optimal adjustment of the bicycle components to each other. In this manner, for instance, one can also perform an adjustment to the stiffness of the running wheels. Particularly, in this regard, it can be advantageous to adjust the trail in a situation where new running wheels are used.

### BRIEF DESCRIPTION OF THE DRAWINGS

A full and enabling disclosure of the present disclosure, including the best mode thereof, enabling one of ordinary skill in the art to carry out the disclosure, is set forth in greater detail in the following description, including reference to the accompanying drawing in which

FIG. 1 is a schematic plan view of a bicycle fork,

FIG. 2 is a schematic perspective view of the dropout ends of the fork legs of a bicycle fork,

FIG. 3 is a schematic, partially sectioned lateral view of a dropout end of the fork leg, seen in the direction indicated by arrow III in FIG. 1,

FIG. 4 is a schematic, perspective exploded view of the dropout end and of the positioning element,

FIGS. 5 and 6 are schematic lateral views of a dropout end of a fork leg of a bicycle fork according to an alternative embodiment of the disclosure, and

FIG. 7 is a schematic lateral view of a dropout end of a fork leg of a bicycle fork according to a further alternative embodiment of the disclosure.

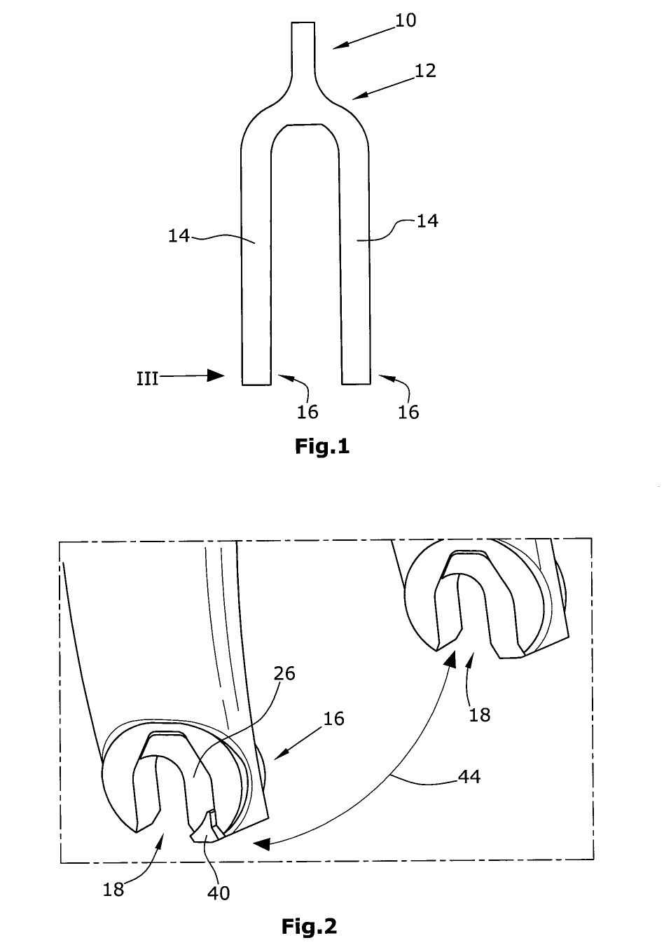

### DETAILED DESCRIPTION OF THE PREFERRED EMBODIMENT

A bicycle fork, which preferably is formed as one piece, comprises a fork shaft 10. Via a fork bridge 12, said fork shaft 10 is connected to two fork legs 14. Dropout ends 16 of said fork legs 14 serve for connection of the front-wheel axis of the front wheel.

According to a first, particularly preferred embodiment of the disclosure (FIGS. 2-4), a recess 18 is provided in said dropout ends 16.

Said recess 18 is defined substantially by the two side walls 20 and an inner wall 22. In the longitudinal direction of the frame or the driving direction, said recesses 18 have a larger width b than conventional recesses of a bicycle fork. Thereby, it is possible, in this embodiment of the disclosure, to arrange a positioning element 26 in recess 18. Said positioning element 26 is substantially L-shaped or hook-shaped. Recess 18 will be partially filled by the positioning element 26, thus leaving a downwardly open opening 28 which in the illustrated embodiment is shaped as a slot. Into said opening 28, the front-wheel axis will be inserted from below in the usual manner. Fixation of the front-wheel axis will normally be effected using a quick-release fastener, with the inner side of said quick-release fastener covering a part of positioning element 26 as well as a part of a holding element 32, as schematically indicated by circle 30. Said holding element 32, preferably made of aluminum, is arranged in dropout end 16. If use is made of a quick-release fastener, this fastener will also fix the positioning elements 26.

The positioning element 26 does not completely surround said slot-shaped opening 28 provided to receive the front-wheel axis. Instead, opening 28 is on one side formed by a lateral wall 34 of a substantially vertical leg of positioning element 26. Opening 28 is further formed by the inner wall 20 of recess 18. An axis-abutment face 36 which in the illustrated embodiment is shaped as a circular arc, forms the upper abutment face for the front-wheel axis.

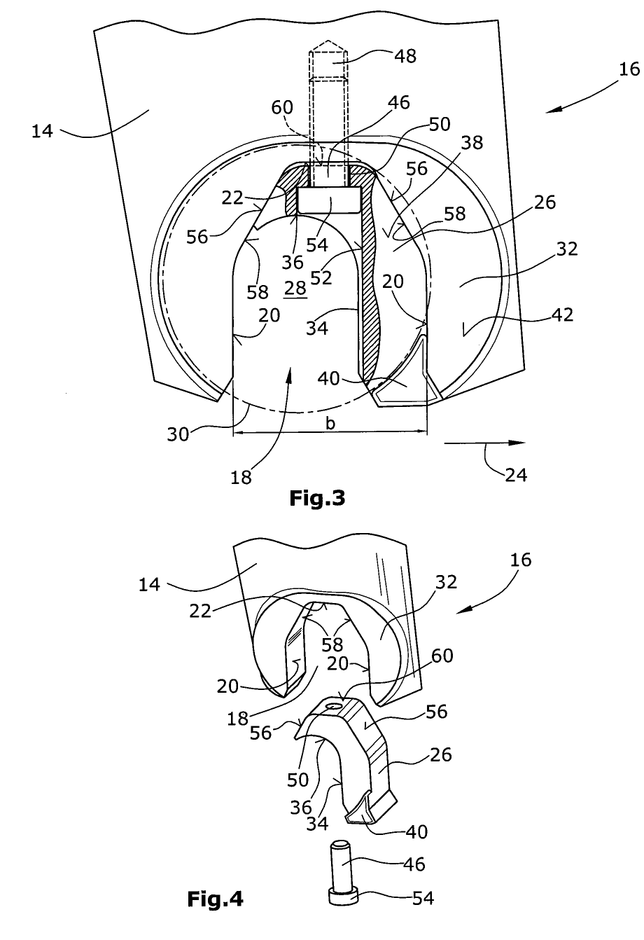

For changing the trail, the positioning element 26 can be pulled out downwardly from recess 18 in FIG. 3, then be rotated by 180° about a vertical axis and be inserted again into recess 18 from below. The vertical leg of positioning element 26 which in FIG. 3 is shown on the right-hand side will then have been arranged on the left side.

In the illustrated preferred embodiment, the positioning elements 26 are provided with a projection 40 extending beyond an outer side 38 of positioning element 26. Said projection 40, which extends also beyond an outer side 42 of the dropout end and respectively of the holding element 32, has the function of preventing the front-wheel axis from sliding out downwardly from slot 28 even when the quick-release fastener has been slightly loosened. This is realized in that the part of the quick-release fastener indicated by circle 30 is in abutment on projection 40, and in that the front wheel can be pulled out from recess 28 only if the quick-release fastener has assumed a wide-opened position.

Thus, when the position of the positioning elements 26 shall be changed, there is preferably performed not only a rotation by 180° but, at the same time, also a mutual exchange of the left and right positioning elements 26, as indicated in FIG. 2 by arrow 44. Thereby, it is safeguarded that the projection 40 will always be facing outward and fulfill its corresponding securement function.

In the illustrated embodiment, for fixing the positioning elements 26 in the holding elements 32, the fastening elements are provided in the form of respective screws 46. These screws 46 will be screwed from below into a threaded bore 48 arranged in holding element 32. For this purpose, the positioning element 26 is provided with a throughgoing bore 50 in a substantially horizontal leg. Said bore 50 further comprises an enlargement 52 for receiving a screwhead 54. Thus, screwhead 54 does not project beyond said axis-abutment face 36.

For clamping attachment of positioning element 26 in recess 18, the positioning element comprises two clamping faces 56 facing toward each other upwardly, i.e. in the direction of fork bridge 12. Said clamping faces 56 are in abutment on corresponding clamping faces 58. Further, in order to guarantee a safe clamping attachment of positioning element 26 while screwing the screw 46 into position, a gap is formed between the inner side 22 of recess 18 and the upper side 60 of positioning element 26. Said gap preferably has a gap width of 0.1 to 0.3 mm.

For fixing the positioning element 26 in recess 18, positioning element 26 (FIG. 4) will be inserted from below into recess 18. There-after, the screw 46 will be fitted through the throughgoing bore 50 of positioning element, and screw 46 will then be fastened in the threaded bore 48. In this manner, the positioning element 26 can be fixed in recess 18 also in a position rotated by 180° about a vertical axis. At the same time, preferably, the left and the right positioning element will be exchanged for each other for safeguarding that the projections 40 will project to the outside.

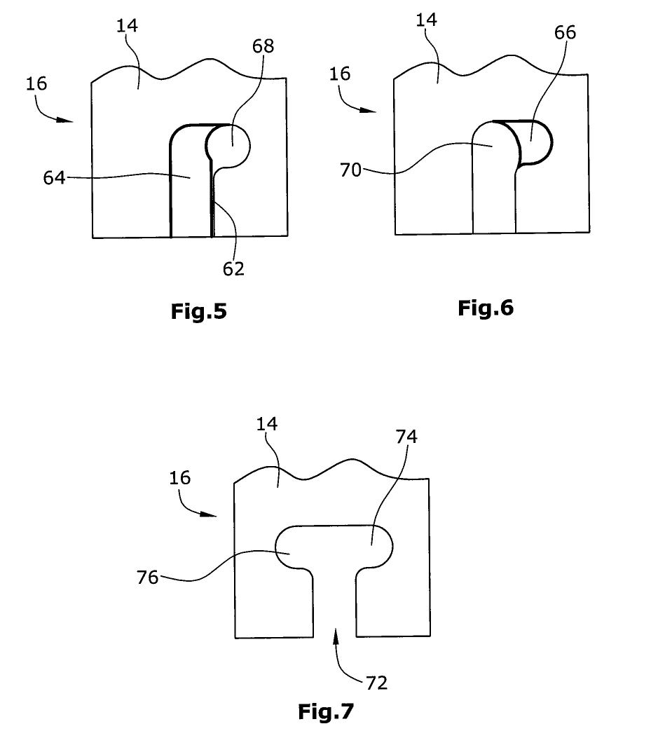

According to an alternative embodiment (FIGS. 5, 6), a dropout end 16 of the fork legs 14 can also be provided with a recess 62 which is P-shaped in lateral view. In said recess 62, a securing element 64 (FIG. 5) and a securing element 66 (FIG. 6) can be arranged. Depending on which one of these securing elements is provided, a recess 68 (FIG. 5) or a recess 70 (FIG. 6) will remain for receiving the front-wheel axis. Also in this manner, it is possible to accommodate the front-wheel axis in two different positions.

Also in a further embodiment (FIG. 7), the above possibility exists. According to this embodiment, the dropout end 16 of bicycle fork 14 is provided with a recess 72 shaped as a T when seen in lateral view. Said recess 72 comprises two extensions 74,76, wherein the front-wheel axis can be arranged in any one of these two extensions. Also thereby, it is possible to arrange the front-wheel axis in different positions. Also here, the remaining area can be filled by a securing element corresponding to said elements 64,66 for safely preventing undesired displacement of the front-wheel axis.

Although the disclosure has been described and illustrated with reference to specific illustrative embodiments thereof, it is not intended that the disclosure be limited to those illustrative embodiments. Those skilled in the art will recognize that variations and modifications can be made without departing from the true scope of the disclosure as defined by the claims that follow. It is therefore intended to include within the disclosure all such variations and modifications as fall within the scope of the appended claims and equivalents thereof.

What is claimed is:

1. A bicycle fork, particularly a bicycle fork for a racing bicycle, said bicycle fork comprising:
two fork legs connected to each other by a fork bridge, and
recesses provided on the respective dropout ends of the fork legs, for receiving a front-wheel axis,
wherein
said recesses are formed in such a manner that the front-wheel axis can be fixed in at least two different positions, particularly in the longitudinal direction of the frame.

2. The bicycle frame according to claim 1, wherein said recesses are formed in a manner allowing a positioning element to be placed therein, said positioning element preferably being adapted to be arranged in different positions in the recess and/or being exchangeable to allow for different positions of the front-wheel axis.

3. The bicycle frame according to claim 2, wherein each of said positioning elements is fixed in the respective dropout end of the fork legs via a respective fastening element, preferably a screw.

4. The bicycle frame according to claim 1, wherein said dropout ends comprise a holding element preferably comprising hard metal such as metal, the respective recess being arranged in said holding element.

5. The bicycle frame according to claim 3, wherein said fastening element is fixed in said holding element.

6. The bicycle frame according to claim 2, wherein said positioning element is substantially L-shaped when seen in lateral view.

7. The bicycle frame according to claim 2, wherein said positioning element comprises a curved axis-abutment face preferably shaped as a circular arc, said axis-abutment face facing towards the fork bridge.

8. The bicycle frame according to claim 7, wherein said axis-abutment face forms an arc in the range of 90°-180°.

9. The bicycle frame according to claim 7, wherein, in the region of said axis-abutment face, said positioning element comprises a throughgoing bore for fitting said fastening element therethrough.

10. The bicycle frame according to claim 2, wherein said positioning element comprises clamping faces running towards each other in the direction of the fork bridge and being in abutment on corresponding clamping faces of the recess.

11. The bicycle frame according to claim 2, wherein a gap is provided between an upper side of the positioning element and an inner side of the recess.

12. The bicycle frame according to claim 1, wherein, by arranging the front-wheel axis at different positions, preferably by turning the positioning elements, the trail is changed by more than 3 mm.

13. The bicycle frame according to claim 2, wherein preferably both of the positioning elements comprise a respective outward projection for preventing the front-wheel axis form sliding out downwardly.

14. The bicycle frame according to claim 8, wherein said axis-abutment face forms an arc in the range of 120°-140°.

15. The bicycle frame according to claim 12, wherein, by arranging the front-wheel axis at different positions, preferably by turning the positioning elements, the trail is changed by more than 4 mm.

16. The bicycle frame according to claim 15, wherein, by arranging the front-wheel axis at different positions, preferably by turning the positioning elements, the trail is changed by more than 5 mm.
